(19) United States
(12) Patent Application Publication
(10) Pub. No.: US 2015/0098229 A1
(43) Pub. Date: Apr. 9, 2015

(54) ILLUMINATION DEVICE

(71) Applicant: PANASONIC INTELLECTUAL PROPERTY MANAGEMENT CO., LTD., Osaka (JP)

(72) Inventors: Tetsushi TAMURA, Nigata (JP); Yukiya KANAZAWA, Osaka (JP); Takuya MATSUMOTO, Osaka (JP); Yoshitaka KURIMOTO, Osaka (JP)

(73) Assignee: PANASONIC INTELLECTUAL PROPERTY MANAGEMENT CO., LTD., Osaka (JP)

(21) Appl. No.: 14/509,263

(22) Filed: Oct. 8, 2014

(30) Foreign Application Priority Data
Oct. 9, 2013 (JP) 2013-212011

(51) Int. Cl. F21V 15/01; F21V 29/00; F21K 99/00; F21V 23/00

(52) U.S. Cl. CPC F21V 15/011; F21V 23/007; F21V 29/004; F21K 9/1355; F21Y 2101/02
USPC 362/382

(57) ABSTRACT

An illumination device includes a light emitting module having a module substrate and a semiconductor light emitting element mounted to the module substrate, a base including a mounting surface on which the light emitting module is mounted, a circuit unit provided at a side of a rear surface of the base opposite to the mounting surface and configured to drive the light emitting unit; and a circuit case which accommodates and holds the circuit unit in an internal space thereof. The circuit case includes a tubular portion having an opening arranged to face the rear surface of the base and an insulation portion interposed between the rear surface of the base and the circuit unit to cover the opening of the tubular portion. The insulation portion includes a window through which the internal space of the circuit case leads to the rear surface of the base.

### CROSS-REFERENCE TO RELATED APPLICATION

This application claims priority to Japanese Patent Application No. 2013-212011 filed on Oct. 9, 2013, the entire contents of which are incorporated herein by reference.

### TECHNICAL FIELD

The present disclosure relates to an illumination device that uses a semiconductor light emitting element including an LED as a light source and, more particularly, to an illumination device in which a light emitting module is mounted to a base and in which a circuit unit and a circuit case are provided at the side of a rear surface of the base.

### BACKGROUND ART

In recent years, with a view to saving energy, a lamp in which a semiconductor light emitting element including an LED (Light Emitting Diode) is used as a light source has been developed as a bulb type lamp for replacing an incandescent bulb. For example, Japanese Patent No. 5126631 discloses a bulb type lamp that includes a light emitting module formed by mounting a semiconductor light emitting element to a mounting substrate, a base for supporting the light emitting module, a circuit unit, a circuit holder, a metal cap and a globe.

In this lamp, the base to which the light emitting module is attached is made of a material superior in heat conductivity, e.g., aluminum. The base serves as a heat sink that dissipates heat generated from the semiconductor light emitting element to the outside.

At the side of a rear surface of the base opposite to the surface on which the light emitting module is mounted, there are provided the circuit unit for driving the light emitting module and the circuit case that includes a tubular portion for accommodating the circuit unit and a cover for covering an opening of the tubular portion. The outer surface of the circuit case is covered by a housing. The circuit case is made of an insulating material. The cover of the circuit case is interposed between the rear surface of the base and the circuit unit. The cover of the circuit case serves to insulate the base and the circuit unit from each other.

This lamp is compact in the device configuration.

When the illumination device is turned on, heat is generated not only from the semiconductor light emitting element but also from the circuit unit. The heat generated from the circuit unit is dissipated from the circuit case to the outside through the metal cap or the like. Particularly, in a high-power illumination device, it is sometimes the case that the circuit unit is heated to a high temperature and is damaged.

### SUMMARY OF THE INVENTION

In view of the above, the present disclosure provides an illumination device capable of suppressing an increase in a temperature of a circuit unit with a simplified configuration.

In accordance with an aspect of the present invention, there is provided an illumination device including: a light emitting module having a module substrate and a semiconductor light emitting element mounted to the module substrate; a base including a mounting surface on which the light emitting module is mounted; a circuit unit provided at a side of a rear surface of the base opposite to the mounting surface and configured to drive the light emitting unit; and a circuit case which accommodates and holds the circuit unit in an internal space thereof, wherein the circuit case includes a tubular portion having an opening arranged to face the rear surface of the base and an insulation portion interposed between the rear surface of the base and the circuit unit to cover the opening of the tubular portion, the insulation portion including a window through which the internal space of the circuit case leads to the rear surface of the base.

The illumination device of the embodiment mentioned above may be configured as follows.

A ratio of an area of the windows to an area defined by an outer edge of the insulation portion may be 20% or more.

The insulation portion may further include one or more windows through which the internal space of the circuit case leads to the rear surface of the base.

The insulation portion may include an engaging portion and the base includes an engaged portion formed on the rear surface of the base, the engaging portion configured to engage with the engaged portion.

A thermally conductive housing may be mounted to an outer surface of the tubular portion

The housing may be connected to the base A filler composed of a thermally conductive material may be filled in the internal space of the circuit case.

According to the illumination device of the embodiment mentioned above, the internal space of the circuit case leads to the rear surface of the base through the window formed in the insulation portion. Therefore, as compared with a case where the insulation portion has no window, heat is well transferred between the internal space of the circuit case and the base.

That is to say, when the illumination device is turned on, the heat generated in the light emitting module is dissipated to the outside through the base. In addition, the heat generated in the circuit unit is transferred to the base through the window and is dissipated to the outside via the base.

In particular, if the amount of heat generated from a high-power circuit unit is large, the amount of heat dissipated from the circuit unit to the outside through the window and the base grows larger.

Therefore, as compared with a case where the insulation portion has no window, it is possible to reduce the temperature within the circuit case.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is a vertical sectional view showing a lamp according to an embodiment.

FIG. 2 is an exploded perspective view of the lamp.

FIG. 3 is an external perspective view of the lamp.

FIG. 4 is a sectional view showing major parts of the lamp.

FIG. 5 is a rear view of the lamp with a tubular portion cut away.

FIG. 6 is a rear exploded perspective view of a base and an insulation portion.

FIG. 7 is a view showing a combination of a light emitting module, a base, a circuit unit, a circuit case and an internal housing.

FIG. 8 is a view showing the results of tests for confirming the heat dissipation effect of the lamp.

FIG. 9 is a vertical sectional view showing a lamp according to a modification of the embodiment in which a filler is filled in an internal space of the circuit case.

### DETAILED DESCRIPTION

### History of the Invention

In an illumination device in which a light emitting module is mounted on a mounting surface of a base and a circuit unit and a circuit case are provided at the side of a rear surface of the base opposite to the mounting surface, it is thinkable to newly provide a heat dissipation member or the like in order to improve dissipation of heat from the inside of the circuit case to the outside. However, it is desirable to make the device configuration as simple as possible.

The present inventors have paid attention to the fact that, if a window is formed in the insulation portion of the circuit case that makes contact with the base and if the internal space of the circuit case is allowed to lead to the rear surface of the base, it is possible to enhance the radiation and convention heat conductivity between the circuit unit and the base while allowing the insulation portion to provide insulation between the circuit unit and the base.

Furthermore, the present inventors have paid attention to the fact that, by enhancing the heat conductivity between the internal space of the circuit case and the base, it is possible for the base not only to dissipate the heat generated in the light emitting module to the outside but also to dissipate the heat generated in the circuit unit to the outside.

Based on this conception, the present inventors have made the present invention.

### Embodiment

### Overall Configuration

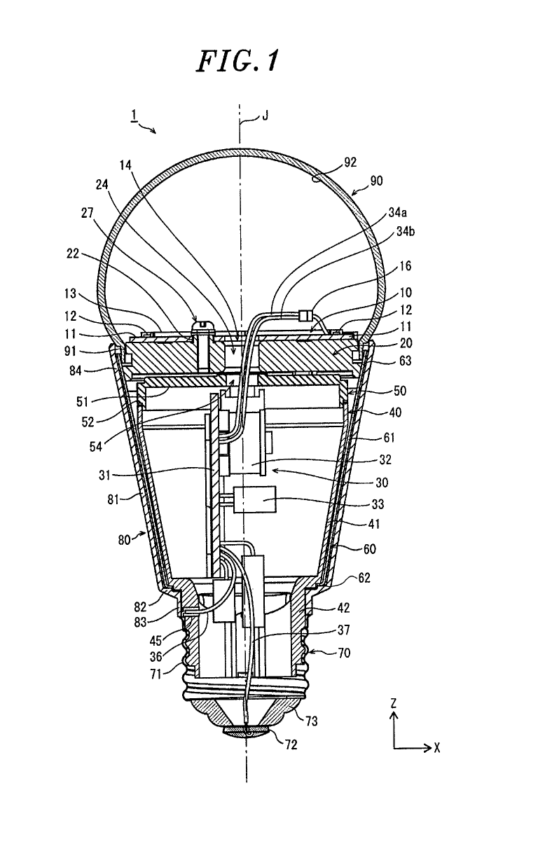

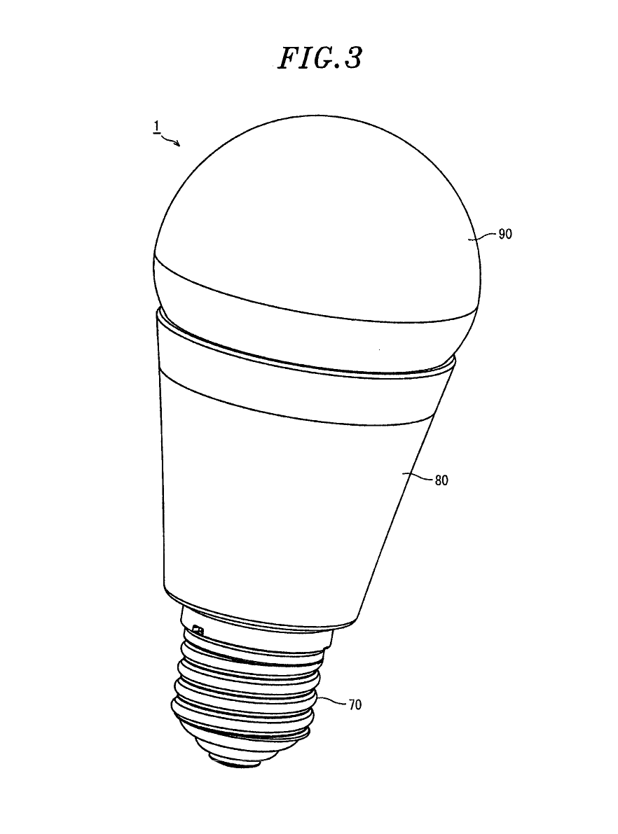

As shown in FIGS. 1 to 3, a lamp 1 is an LED lamp used as a substitute of an incandescent bulb.

Referring to FIG. 1, a single-dot chain line extending in an up-down direction on a drawing sheet indicates a lamp axis J of the lamp 1. The lamp axis J is an axis about which the lamp 1 rotates when the lamp 1 is mounted to a socket of a luminaire. The lamp axis J coincides with a rotation axis of a metal cap 70. The upper side on the drawing sheet in FIG. 1 will be referred to as a front side of the lamp 1.

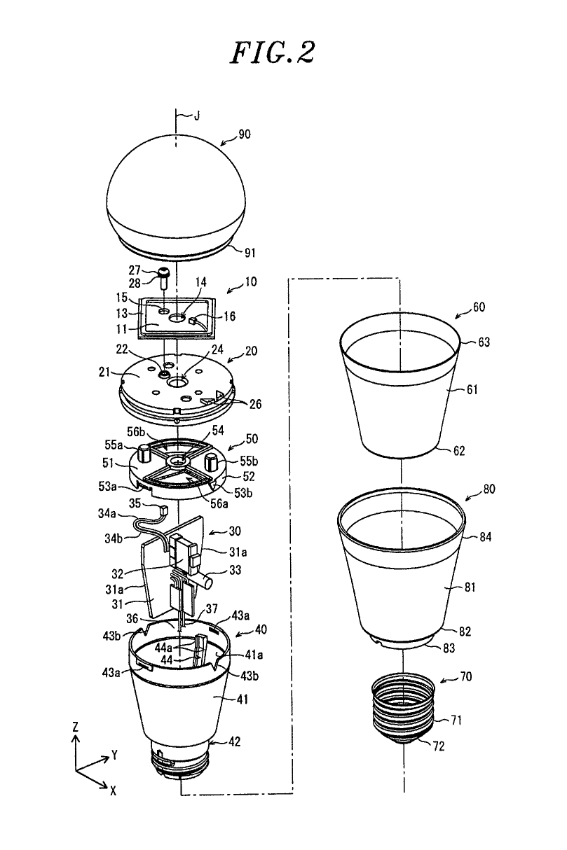

As shown in FIGS. 1 and 2, the lamp 1 includes a light emitting module 10, a base 20 to which the light emitting module 10 is mounted, a circuit unit 30 for driving the light emitting module 10, a circuit case (a tubular portion 40 and an insulation portion 50) for accommodating the circuit unit 30 therein, an internal housing 60, a metal cap 70, an external housing 80, a globe 90, and so forth.

Configurations of the respective parts will now be described in detail.

<Light Emitting Module 10>

The light emitting module 10 includes a module substrate 11, a plurality of semiconductor light emitting elements 12 mounted to the module substrate 11 and an encapsulation member 13 encapsulating the semiconductor light emitting elements 12.

As shown in FIG. 2, the encapsulation member 13 is formed into a ring shape on an upper surface of an outer periphery portion of the module substrate 11. A wiring pattern is formed on the upper surface of the outer periphery portion of the module substrate 11. The semiconductor light emitting elements 12 are mounted on the wiring pattern. The wiring pattern and the semiconductor light emitting elements 12 are not visible in FIG. 2 because they are covered with the encapsulation member 13.

A power-feeding connector 16 is connected to the wiring pattern of the module substrate 11. The module substrate 11 used in the present embodiment is a ceramic substrate formed by mixing a glass component with a ceramic such as an aluminum oxide, an aluminum nitride or a silicon nitride and baking the mixed material. A wiring pattern is formed on the ceramic substrate. However, the module substrate 11 is not limited to the ceramic substrate. Other substrates such as a resin substrate and a metal-based substrate formed of a resin and a metal may be used as the module substrate 11.

For example, GaN-based LEDs that emit blue light are used as the semiconductor light emitting elements 12. The semiconductor light emitting elements 12 are mounted on the upper surface of the outer periphery portion of the module substrate 11 through the use of a COB (Chip-On-Board) technique.

The encapsulation member 13 is configured by mixing a wavelength conversion material, which is capable of converting the wavelength of the light emitted from the semiconductor light emitting elements 12, into a light transmitting material. For example, a silicon resin is used as the light transmitting material. For example, yellow phosphor particles for converting blue light to yellow light can be used as the wavelength conversion material.

A through-hole 14 through which lead wires 34a and 34b for receiving electric power from the circuit unit 30 pass is formed in the central portion of the module substrate 11.

Furthermore, a through-hole 15 is formed in the module substrate 11. A protrusion 22 of the base 20 is fitted into the through-hole 15.

The through-hole 14 and the through-hole 15 are formed in a central portion of the module substrate 11 where the wiring pattern is not disposed.

In the present embodiment, the light emitting unit is formed of COB type LEDs. Alternatively, the light emitting unit may be formed of SMD (surface mount device) type LEDs.

<Base 20>

As shown in FIG. 2, the base 20 is a substantially disc-shaped member. The upper surface of the base 20 serves as a mounting surface 21 on which the light emitting module 10 is mounted. The light emitting module 10 is bonded and fixed to the mounting surface 21 through an adhesive layer. The base 20 is made of a thermally conductive material so that the heat generated in the light emitting module 10 can be efficiently dissipated to the outside.

The base 20 may be manufactured by injection-molding a thermally conductive resin or may be manufactured by pressing or die-casting a thermally conductive material such as a metal or the like.

Examples of the thermally conductive material may include a pure metal composed of a single metal element such as aluminum, tin, zinc, indium, iron, copper, silver, nickel, rhodium, palladium or the like, an alloy composed of a plurality of metal elements, and an alloy composed of a metal element and a nonmetal element.

Examples of the thermally conductive resin material may include polypropylene, polypropylene sulfide, polycarbonate, polyetherimide, polyphenylene sulfide, polyphenylene oxide, polysulfone, polybutylene terephthalate, polyamide, polyethylene terephthalate, polyether sulfone, and polyphthalamide.

A mixture of a resin material and a thermally conductive filler may be used. As the thermally conductive filler, it is possible to use, e.g., a filler composed of an inorganic material such as glass, silicon oxide, beryllium oxide, aluminum oxide, magnesium oxide, zinc oxide, silicon nitride, boron nitride, titanium nitride, aluminum nitride, diamond, graphite, silicon carbide, titanium carbide, zirconium boride, phosphorus boride, molybdenum silicide, beryllium sulfide, aluminum, tin, zinc, indium, iron, copper, silver or the like. Different kinds of fillers may be used in combination.

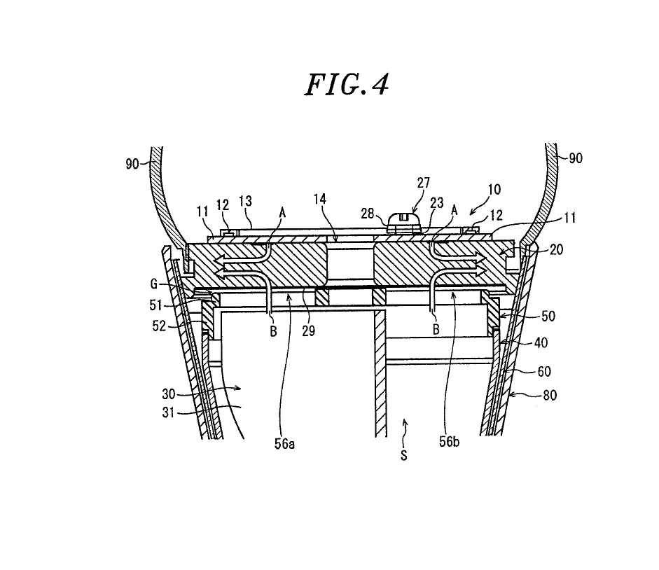

As shown in FIG. 2, a through-hole 24 is formed in the central portion of the base 20. As will be described later in detail, the lead wires 34a and 34b are inserted through the through-hole 24. The base 20 includes the protrusion 22 and a pair of ribs 26, both of which protrude from the mounting surface 21. A pair of depressions 25a and 25b for mounting the insulation portion 50 of the circuit case is formed on a rear surface 29 of the base 20 (see FIG. 4).

<Circuit Unit 30>

The circuit unit 30 receives electric power from the illumination device through the metal cap 70. The circuit unit 30 serves to convert the electric power and to supply the converted electric power to the light emitting module 10. The circuit unit 30 includes a circuit board 31, a plurality of electronic parts 32 and 33 mounted on one major surface (the mounting surface) of the circuit board 31, and a wiring pattern (not shown) arranged on the other major surface (the surface opposite from the mounting surface) of the circuit board 31. In the figures, only some of the electronic parts are designated by reference symbols “32” and “33”.

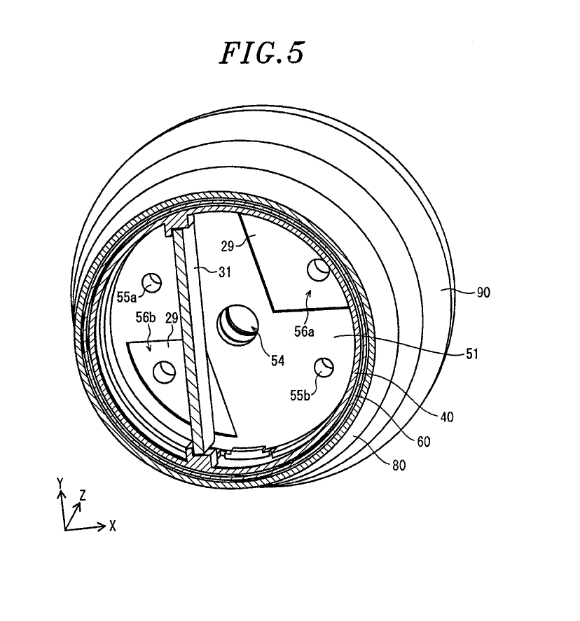

The circuit unit 30 is held on the rear surface 29 of the base 20 by the circuit case. As shown in FIGS. 1 and 5, the circuit board 31 is disposed in a position deviated from the lamp axis J. This makes it possible to mount an electronic part having a large volume to the circuit board 31.

A pair of lead wires 34a and 34b for supplying electric power to the light emitting module 10 is connected to the circuit unit 30. A connector 35 is connected to the tips of the lead wires 34a and 34b.

The lead wires 34a and 34b extend toward the front side through the through-hole 54 of the insulation portion 50, the through-hole 24 of the base 20 and the through-hole 14 of the light emitting module 10. The connector 35 is attached to the tips of the lead wires 34a and 34b. The connector 35 is connected to the connector 16 attached to the light emitting module 10. In this way, a power supply line extending from the circuit unit 30 to the light emitting module 10 is formed by the lead wires 34a and 34b.

As shown in FIG. 1, the circuit unit 30 and the metal cap 70 are electrically connected to each other by a pair of lead wires 36 and 37.

<Circuit Case>

The circuit case includes a tubular portion 40 and an insulation portion 50, both of which are provided at the side of the rear surface 29 of the base 20.

The tubular portion 40 is arranged such that the front opening thereof faces toward the rear surface 29 of the base 20. The insulation portion 50 is attached so as to close the opening of the tubular portion 40. The insulation portion 50 is interposed between the rear surface 29 of the base 20 and the circuit unit 30. The axis of the circuit case coincides with the lamp axis J.

The tubular portion 40 is a tubular member having a large diameter portion 41 and a small diameter portion 42. The tubular portion 40 holds the circuit unit 30 therein. The front opening of the large diameter portion 41 of the tubular portion 40 faces toward the rear surface of the base 20. The small diameter portion 42 extends from the rear end of the large diameter portion 41. The metal cap 70 is externally fitted to the small diameter portion 42.

The large diameter portion 41 has a cylindrical shape with the diameter thereof gradually decreasing from the front side toward the back side. The circuit unit 30 is mostly accommodated within the large diameter portion 41.

As shown in FIG. 2, a pair of ribs 44a extending parallel to each other along the lamp axis J is provided on the inner circumferential surface 41a of the large diameter portion 41. A groove 44 is formed between the ribs 44a.

In FIG. 2, the ribs 44a and the groove 44 are shown at one point on the inner circumferential surface 41a. In reality, two pairs of ribs 44a and two grooves 44 are formed at two points. The opposite edges 31a of the circuit board 31 are respectively inserted into the two grooves 44, whereby the circuit board 31 is held within the tubular portion 40 with the major surfaces thereof extending along the lamp axis J.

The tubular portion 40 is made of, e.g., an electric insulation material such as a resin material or an inorganic material.

Examples of the resin material may include a thermoplastic resin and a thermosetting resin. More specifically, examples of the resin material may include polybutylene terephthalate, polyoxymethyl, polyamide, polyphenyl sulfide, polycarbonate, acryl, fluorine-based acryl, silicon-based acryl, epoxy acrylate, polystyrene, acrylonitrile styrene, cycloolefin polymers, methyl styrene, fluorene, polyethylene terephthalate, polypropylene, phenol resins, and melamine resins.

Examples of the inorganic material may include glass, ceramics, silica, titania, alumina, silica alumina, zirconia, zinc oxide, barium oxide, strontium oxide, and zirconium oxide.

The insulation portion 50 is mounted to the front end opening of the large diameter portion 41 of the tubular portion 40 so as to close the opening of the tubular portion 40. The insulation portion 50 is interposed between the rear surface 29 of the base 20 and the circuit board 31 of the lamp 1. The insulation portion 50 serves to provide insulation by preventing the circuit board 31 from getting closer to the rear surface 29 of the base 20.

The insulation portion 50 is a cap-shaped member mounted to the front end opening of the large diameter portion 41. The insulation portion 50 includes a disc-shaped top plate portion 51 and a circumferential wall portion 52 bent backward from the outer edge of the top plate portion 51.

The insulation portion 50 may be made of the same material as the tubular portion 40. As shown in FIG. 1, the circumferential wall portion 52 has an outer diameter substantially equal to the diameter of the front edge of the large diameter portion 41. The rear edge of the circumferential wall portion 52 is fitted into the front edge of the large diameter portion 41.

A claw 53a and a lug 53b are formed on the outer circumferential surface of the circumferential wall portion 52. In the front end portion of the large diameter portion 41, there are formed an engagement hole 43a with which the claw 53a engages and a cutout 43b into which the lug 53b is fitted. As the claw 53a and the engagement hole 43a engage with each other, the insulation portion 50 is mounted to the front end of the tubular portion 40.

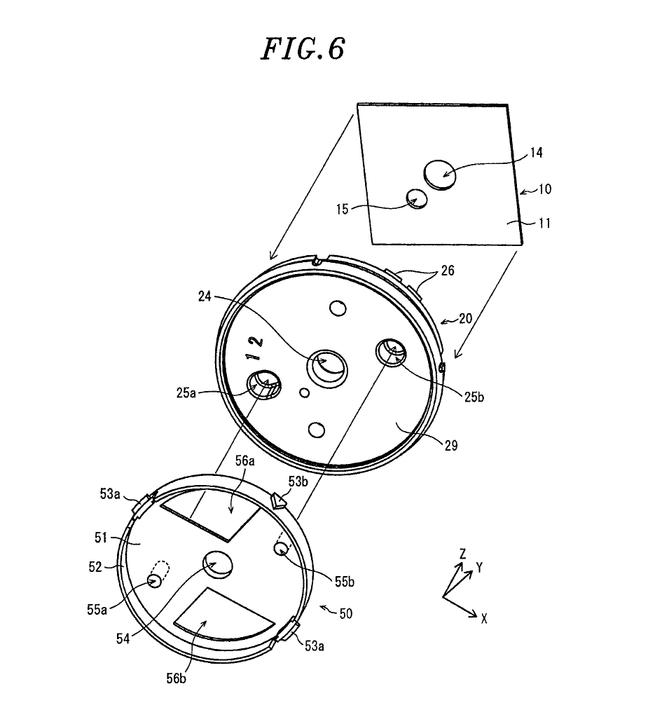

As shown in FIG. 2, a pair of projections 55a and 55b protruding forward from the top plate portion 51 is formed in the insulation portion 50. The projections 55a and 55b are inserted into the depressions 25a and 25b of the base 20 as shown in FIG. 6.

As the projections 55a and 55b are fitted into the depressions 25a and 25b, the insulation portion 50 is positioned adjacent to the rear surface 29 of the base 20 and is fixed in an aligned state. This makes it easy to perform an assembling work of the lamp 1.

When the lamp 1 is in an assembled state, as shown in FIG. 1, the top plate portion 51 of the insulation portion 50 is interposed between the base 20 and the circuit unit 30. Thus, the base 20 and the circuit unit 30 are spaced apart from each other. This provides insulation between the base 20 and the circuit unit 30.

Windows 56a and 56b are formed in the top plate portion 51 of the insulation portion 50. The windows 56a and 56b as a whole face toward the rear surface 29 of the base 20. Thus, the internal space of the circuit case leads to the rear surface 29 of the base 20 through the windows 56a and 56b as will be described later. For that reason, heat is well transferred between the internal space of the circuit case and the base 20 by radiation and convection.

<Internal Housing 60>

The internal housing 60 is a cylindrical member that covers the outer circumferential surface of the large diameter portion 41 of the tubular portion 40.

The internal housing 60 is made of a thermally conductive material. The internal housing 60 serves as a heat dissipation member (heat sink) that, when the lamp 1 is turned on, dissipates the heat generated from the light emitting module 10 and the circuit unit 30 toward the metal cap 70.

The internal housing 60 may be made of the same material as the base 20. The internal housing 60 includes a cylindrical body portion 61 and a ring-shaped locking portion 62 extending from the lower end of the body portion 61.

The body portion 61 has a diameter gradually decreasing from the front side toward the back side. The body portion 61 is externally fitted to the large diameter portion 41 of the tubular portion 40.

As shown in FIG. 1, the base 20 is internally fitted to a front end portion 63 of the body portion 61. The front end portion 63 of the internal housing 60 is fixed to the outer circumferential portion of the base 20 by caulking or the like.

The outer circumferential surface of the base 20 makes face-to-face contact with the inner circumferential surface of the front end portion 63 of the internal housing 60. Thus, heat is easily transferred from the base 20 to the internal housing 60.

The heat transferred from the base 20 to the internal housing 60 is predominantly transferred to the metal cap 70 via the small diameter portion 42 of the tubular portion 40 and is dissipated from the metal cap 70 toward the luminaire.

<Metal Cap 70>

The metal cap 70 is a member that receives electric power from the socket of the luminaire when the lamp 1 is turned on.

The metal cap 70 is attached so as to close the opening of the small diameter portion 42 of the tubular portion 40. The kind of the metal cap 70 is not particularly limited. In the present embodiment, an E26 metal cap of Edison type is used as the metal cap 70. The metal cap 70 includes a substantially cylindrical shell portion 71 having a male thread formed on the outer circumferential surface thereof and an eyelet portion 72 attached to the shell portion 71 through an insulation portion 73.

The lead wire 36 connected to the circuit unit 30 is extended through a through-hole 45 of the small diameter portion 42 of the tubular portion 40 to be connected to the shell portion 71. The lead wire 37 is extended through the small diameter portion 42 to be connected to the eyelet portion 72.

If the metal cap 70 is attached to the socket of the luminaire, electric power is supplied from the luminaire to the circuit unit 30 via the metal cap 70 and the lead wires 36 and 37.

<External Housing 80>

The external housing 80 includes a tubular outer shell portion 81 for covering the outer circumferential surface of the internal housing 60, a circular ring portion 82 bent from the rear end of the outer shell portion 81 toward the lamp axis J, and a tubular insulation portion 83 extending backward from the inner edge of the circular ring portion 82.

The external housing 80 is made of an electric insulation material. Specific examples of the electric insulation material may include a resin material or an inorganic material identical with the material of the tubular portion 40 described above.

The outer shell portion 81 has a substantially cylindrical shape with the diameter thereof gradually decreasing from the front side toward the back side. The internal housing 60 and the large diameter portion 41 are accommodated within the outer shell portion 81. As shown in FIG. 1, the circular ring portion 82 presses the locking portion 62 of the internal housing 60 against the large diameter portion 41, thereby fixing the internal housing 60 to the tubular portion 40 of the circuit case.

The insulation portion 83 is externally fitted to the root portion of the small diameter portion 42. Since the insulation portion 83 is interposed between the body portion 61 of the internal housing 60 and the metal cap 70, electric insulation is provided between the internal housing 60 and the metal cap 70.

The front edge portion 84 of the external housing 80 surrounds the outer circumferential surface of the base 20.

<Globe 90>

The globe 90 is a substantially dome-shaped member that covers the front side of the light emitting module 10. The globe 90 is made of, e.g., a light-transmitting resin material or a glass.

As shown in FIG. 1, an opening-side end portion 91 of the globe 90 is inserted between the outer circumferential surface of the base 20 and the front edge portion 84 of the external housing 80 and is fixed thereto by an adhesive agent (not shown).

An inner surface 92 of the globe 90 may be subjected to a diffusion treatment so as to diffuse the light emitted from the light emitting module 10. As a diffusion treatment method, it is possible to use, e.g., a method by which a mixture of silica or white pigment and a coating material is coated on the inner surface 92 of the globe 90.

<Mounting of Light Emitting Module 10 to Base 20>

As shown in FIGS. 1 and 2, the light emitting module 10 is mounted on the mounting surface 21 of the base 20.

The module substrate 11 is mounted on the mounting surface 21 in such a positioning state that the through-hole 15 of the module substrate 11 is fitted to the protrusion 22 of the base 20 and that one corner portion of the module substrate 11 is inserted between the ribs 26.

As described above, the base 20 is provided with the protrusion 22 and the ribs 26, both of which serve to reliably position the module substrate 11 in place on the mounting surface 21. Thus, the ease of a work of mounting the light emitting module 10 to the base 20 is enhanced.

The rear surface of the module substrate 11 of the light emitting module 10 and the mounting surface 21 of the base 20 is bonded to each other by an adhesive layer.

The adhesive layer is formed of an adhesive material superior in heat conductivity, e.g., a silicon adhesive agent.

The adhesive layer can be formed by coating a silicon adhesive agent on the mounting surface 21 or the rear surface of the module substrate 11 or attaching a silicon adhesive sheet to the mounting surface 21 or the rear surface of the module substrate 11 before the light emitting module 10 is mounted to the mounting surface 21.

In this way, the module substrate 11 and the mounting surface 21 of the base 20 are bonded to each other. For that reason, the heat generated in the light emitting module 10 is efficiently transferred to the base 20 and is dissipated to the outside through the base 20.

The base 20 is provided with a removal-preventing mechanism that prevents the light emitting module 10 from being removed from the base 20 even when the adhesive layer between the module substrate 11 and the mounting surface 21 is peeled off.

As shown in FIG. 2, the base 20 is provided with the protrusion 22 that protrudes upward from the mounting surface 21 in close proximity to the edge of the module substrate 11. The protrusion 22 may make contact with the edge of the module substrate 11. A washer 28 is fastened to the top surface of the protrusion 22 by a fastener 27. In the present embodiment, a screw is used as the fastener 27.

The outer diameter of the washer 28 is set larger than the diameter of the top surface of the protrusion 22. Thus, the outer periphery portion of the washer 28 is overhung from the top portion of the protrusion 22 in an eaves shape.

Since the outer diameter of the washer 28 is set larger than the diameter of the through-hole 15, the washer 28 covers the inner edge portion of the through-hole 15 of the module substrate 11.

Inasmuch as the height of the protrusion 22 is set equal to or larger than the thickness of the module substrate 11, the washer 28 does not apply any pressing force to the surface of the module substrate 11.

Therefore, even if the module substrate 11 attempts to move away from the mounting surface 21 when the adhesive layer is degraded and when the module substrate 11 is detached from the mounting surface 21, the protruding portion of the washer 28 makes contact with the module substrate 11. Thus, the module substrate 11 cannot move away from the mounting surface 21. Accordingly, the light emitting module 10 is prevented from being removed from the base 20.

Moreover, the module substrate 11 of the light emitting module 10 does not receive any pressing force from the washer 28. Therefore, there is no possibility that the module substrate 11 is cracked by a pressing force.

<Method for Assembling the Lamp 1>

The light emitting module 10 is mounted to the base 20. The circuit unit 30 is accommodated within the circuit case. The base 20 mounted with the light emitting module 10 and the circuit case mounted with the circuit unit 30, are combined together. The internal housing 60 is mounted to the circuit case. In this regard, the base 20 and the circuit case are combined by respectively fitting the projections 55a and 55b to the depressions 25a and 25b.

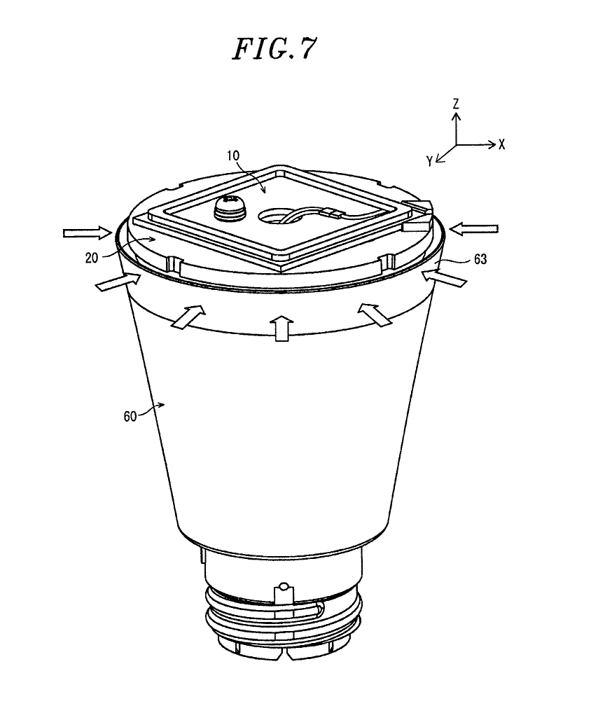

FIG. 7 shows a combination of the light emitting module 10, the base 20, the circuit unit 30, the circuit case and the internal housing 60.

Then, the internal housing 60 is held and fixed such that the front end portion 63 of the internal housing 60 makes face-to-face contact with the outer periphery portion of the base 20. In FIG. 7, white arrows indicate that the front end portion 63 of the internal housing 60 is pressed toward the lamp axis J and is fixed to the outer periphery portion of the base 20.

As mentioned above, the projections 55a and 55b of the circuit case are respectively fitted to the depressions 25a and 25b of the base 20. The internal housing 60 is externally fitted to the circuit case. Thus, the internal housing 60 and the circuit case are held in a mutually aligned state. This makes it possible to easily perform the caulking process.

Next, the external housing 80 is mounted to the outer surface of the internal housing 60. The metal cap 70 is mounted to the external housing 80. The opening-side end portion 91 of the globe 90 is inserted between the outer circumferential surface of the base 20 and the front edge portion 84 of the external housing 80 and is fixed thereto by an adhesive agent or the like.

In the present embodiment, the projections 55a and 55b are provided at the insulation portion 50 and the depressions 25a and 25b are formed in the base 20. Conversely, projections may be provided at the rear surface of the base 20 and depressions fitted to the projections may be formed in the insulation portion 50. In a broad sense, the same effect as mentioned above can be obtained by providing an engaging portion to the insulation portion 50 and providing an engaged portion engageable with the engaging portion to the base 20.

<Heat Dissipation Enhancing Effect Provided by the Windows 56a and 56b of the Insulation Portion 50 of the Lamp 1>

FIG. 4 is a sectional view of major parts of the lamp 1, which is taken across the windows 56a and 56b of the insulation portion 50 along the lamp axis J. FIG. 5 is a rear view of the lamp 1 obtained by cutting a portion of the tubular portion 40. In FIGS. 4 and 5, only the circuit board 31 of the circuit unit 30 is shown with the electronic parts omitted.

As described above, the lamp 1 includes the light emitting module 10 having the light emitting unit formed by mounting the semiconductor light emitting elements 12 on the module substrate 11, and the base 20 having the mounting surface 21 on which the light emitting module 10 is mounted. The circuit unit 30 for driving the light emitting module 10 and the circuit case for accommodating and holding the circuit unit 30 therein are provided at the side of the rear surface 29 of the base 20 opposite to the mounting surface 21.

As shown in FIGS. 4 and 5, the windows 56a and 56b facing the rear surface 29 of the base 20 are formed in the top plate portion 51 of the insulation portion 50. As a result, the internal space S of the circuit case formed of the tubular portion 40 and the insulation portion 50 leads to the rear surface 29 of the base 20 through the windows 56a and 56b.

Therefore, according to the present lamp 1, as compared with a case where the insulation portion 50 has no window, heat is well transferred between the internal space S and the base 20 (by radiation and convection of an air).

The heat generated in the light emitting module 10 when the lamp 1 is turned on is dissipated to the outside through the base 20 as indicated by arrows A in FIG. 4.

On the other hand, the heat generated in the circuit unit 30 when the lamp 1 is turned on is partially dissipated from the tubular portion 40 to the outside through the internal housing 60. There is also formed a heat transfer route in which the heat generated in the circuit unit 30 is transferred from the circuit unit 30 to the base 20 through the windows 56a and 56b and is dissipated to the outside through the base 20 as indicated by arrows B in FIG. 4.

In particular, if the lamp 1 is high in output power and if the amount of heat generated from the circuit unit 30 is large, the amount of heat dissipated from the circuit unit 30 to the outside through the windows 56a and 56b and the base 20 grows larger.

Thus, according to the present lamp 1, overall heat dissipation is enhanced just as much as the enhancement of dissipation of heat through the windows 56a and 56b and the base 20. Accordingly, the internal temperature of the circuit case is reduced.

(Opening Ratio and Shape of the Windows in the Insulation Portion 50)

In order to obtain the aforementioned heat dissipation effect, the opening ratio of the top plate portion 51 is preferably 1/5 (20%) or more and more preferably 1/3 or more. On the other hand, for the purpose of securing the strength of the insulation portion 50, the opening ratio is preferably 3/5 or less.

The term “opening ratio” referred to herein means the ratio of an area of the windows 56a and 56b to a surface area of the top plate portion 51 (an area defined by the outer edge of the top plate portion 51) including the area of the through-hole 54 and the area of the windows 56a and 56b.

The lead wires 34a and 34b are inserted into the through-hole 54 formed at the center of the top plate portion 51. The through-hole 54 communicates with the through-hole 24 of the base 20 and does not face the rear surface 29 of the base 20. The opening ratio in the top plate portion 51 means the occupying ratio of the windows 56a and 56b excluding the occupying ratio of the through-hole 54 in the top plate portion 51.

In the example shown in FIGS. 2 and 6, two fan-shaped windows 56a and 56b are formed in the top plate portion 51 in a symmetrical relationship with respect to the lamp axis J. If the windows 56a and 56b are symmetrically formed with respect to the center point of the top plate portion 51 in this way, it becomes possible to enhance the convection heat transfer effect.

Owing to the enhancement of the heat transfer effect, the heat dissipation of the lamp 1 as a whole is enhanced as will be described later.

The shape, number and position of the windows formed in the top plate portion 51 are not limited to the ones described above.

The shape of the windows formed in the top plate portion 51 is not particularly limited but may be an arbitrary shape such as a circular shape or a polygonal shape.

Moreover, the windows may be notches formed by cutting the circumferential wall portion 52. Even in this case, the aforementioned heat dissipation effect is obtained.

However, in order to maintain the strength of the insulation portion 50, it is preferred that the windows formed in the top plate portion 51 are not notches and that the outer peripheries of the windows are surrounded by the material of the insulation portion 50.

Only one opening may be formed in the top plate portion 51. However, if openings are formed at a plurality of points even at the same opening ratio, the openings are dispersedly arranged over a wide region of the rear surface 29 of the base 20.

Accordingly, heat is dissipated from the internal space S to the base 20 over a wide region. This makes it possible to enhance the heat dissipation effect.

In case where a gap (designated by reference symbol G in FIG. 4) exists between the rear surface 29 of the base 20 and the top plate portion 51 of the insulation portion 50, if a plurality of windows is formed in the top plate portion 51, it can be expected that the air within the circuit case circulates through the gap and the windows, thereby enhancing the heat dissipation effect.

In order to enhance the heat dissipation effect, it is preferred that the windows are uniformly dispersed over a wide region of the top plate portion 51 without being concentrated with respect to the rear surface 29 of the base 20.

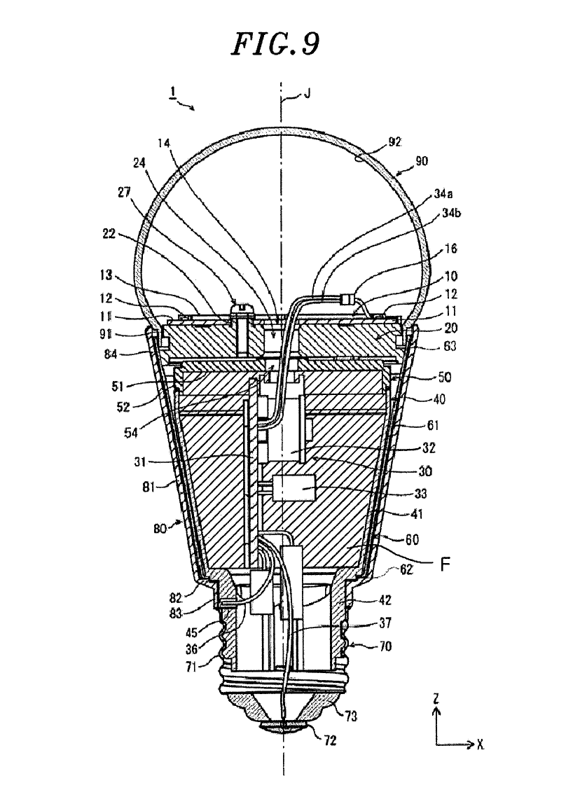

As shown in FIG. 9, a thermally conductive resin F such as a silicon resin or the like may be filled in the internal space of the circuit case (see FIG. 9). The thermally conductive resin may be filled in the windows 56a and 56b of the insulation portion 50, or may be arranged in a portion of the internal space or the like. In this case, heat is well transferred from the circuit unit 30 to the circuit case and the base 20 through the silicon resin thus filled or arranged. This makes it possible to further enhance the heat dissipation.

(Tests)

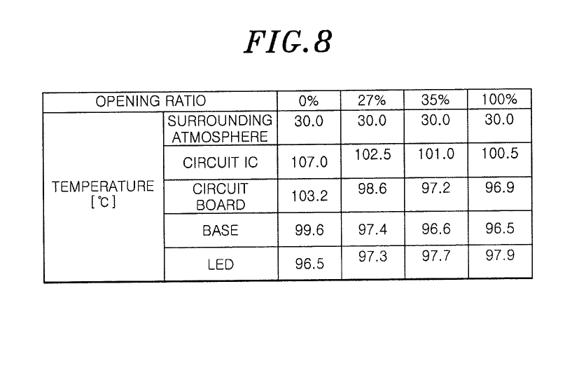

Tests were conducted to confirm the heat dissipation effect provided by the formation of the windows in the insulation portion 50 of the lamp 1. In conducting the tests, as shown in FIG. 8, the opening ratio of the insulation portion 50 of the lamp 1 was changed to 0%, 27%, 35% and 100%. The temperatures of the surrounding atmosphere, the circuit IC, the circuit board 31, the base 20 and the LED (the light emitting module 10) were measured.

The lamps used in the tests have the following common specifications.

The brightness specification of the lamps is equivalent to 100 W and the power consumption of the lamps is 14.1 W.

The base 20 and the internal housing 60 are all made of aluminum. The external housing 80 and the circuit case (the tubular portion 40 and the insulation portion 50) are all made of polybutylene terephthalate.

No filler was used.

The test results are shown in FIG. 8. As compared with a case where the insulation portion 50 has no window (the opening ration is 0%), the temperatures of the circuit unit 30, the base 20 and the light emitting module 10 were reduced when the windows were formed in the insulation portion 50 at the opening ratios of 27%, 35% and 100%.

The test results indicate that the heat dissipation effect can be enhanced by setting the opening ratio of the insulation portion 50 to become 20% or more.

<Others>

In the lamp 1 described above, the insulation portion 50 is formed of the top plate portion 51 and the circumferential wall portion 52. The circumferential wall portion 52 is fitted to the front end of the tubular portion 40. Alternatively, the circumferential wall portion 52 may be omitted from the insulation portion 50. For example, a disc-shaped insulation portion may be mounted so as to close the front opening of the tubular portion 40. Even in this case, the same effect as described above can be obtained by forming windows in the insulation portion.

In the aforementioned embodiment, description has been made by taking a bulb type LED lamp as an example. However, the present invention is equally applicable to an illumination device in which a light emitting module provided with a semiconductor light emitting element is mounted to a base and in which a circuit unit for driving a light emitting module and a circuit case for accommodating and holding the circuit unit therein are provided at the side of the rear surface of the base.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An illumination device, comprising:
a light emitting module including a module substrate and a semiconductor light emitting element mounted to the module substrate;
a base including a mounting surface on which the light emitting module is mounted;
a circuit unit provided at a side of a rear surface of the base opposite to the mounting surface and configured to drive the light emitting unit; and
a circuit case which accommodates and holds the circuit unit in an internal space thereof,
wherein the circuit case includes a tubular portion having an opening arranged to face the rear surface of the base and an insulation portion interposed between the rear surface of the base and the circuit unit to cover the opening of the tubular portion, the insulation portion including a window through which the internal space of the circuit case leads to the rear surface of the base.

2. The illumination device of claim 1, wherein a ratio of an area of the window to an area defined by an outer edge of the insulation portion is 20% or more.

3. The illumination device of claim 1, wherein the insulation portion further includes one or more windows through which the internal space of the circuit case leads to the rear surface of the base.

4. The illumination device of claim 1, wherein the insulation portion includes an engaging portion and the base includes an engaged portion formed on the rear surface of the base, the engaging portion configured to engage with the engaged portion.

5. The illumination device of claim 1, wherein a thermally conductive housing is mounted to an outer surface of the tubular portion, and is connected to the base.

6. The illumination device of claim 1, wherein a filler formed of a thermally conductive material is filled in the internal space of the circuit case.
